(19) United States
(12) Patent Application Publication
(10) Pub. No.: US 2025/0206607 A1
(43) Pub. Date: Jun. 26, 2025

(54) METHOD AND APPARATUS FOR SEPARATING A COMPONENT MIXTURE

(71) Applicant: Linde GmbH, Pullach (DE)

(72) Inventors: Werner LEITMAYR, Pullach (DE); Torben HÖFEL, Pullach (DE); Patrick SCHIFFMANN, Pullach (DE); Thilo Frank Theodor VON TROTHA, Pullach (DE)

(21) Appl. No.: 18/847,535

(22) PCT Filed: Mar. 9, 2023
(86) PCT No.: PCT/EP2023/025109

§ 371 Date: Sep. 16, 2024

(30) Foreign Application Priority Data
Mar. 21, 2022 (EP) 22020120.6

(51) Int. Cl. C01B 3/50

(52) U.S. Cl. CPC C01B 3/508; C01B 2210/0045; C01B 2210/0046; C01B 2210/005; C01B 2210/007

(57) ABSTRACT

A method for separating hydrogen from methane in a component mixture containing light components, wherein a feed stream is formed at a first pressure level, wherein the feed stream is subjected to a pressure step, wherein a high-pressure product at the first pressure level and a low-pressure product at a second pressure level below the first pressure level are withdrawn from the pressure step, wherein a membrane stream is formed at a third pressure level using the low-pressure product or a part thereof, wherein the membrane feed-stream is subjected to a separation step, wherein a retentate and a permeate are withdrawn from the separation step, wherein the feed stream is formed using the permeate or a part thereof, and wherein the feed stream and/or the membrane stream is formed using the component mixture or a part thereof.

The present invention relates to a method and to an apparatus for separating a component mixture containing light components.

### BACKGROUND

Very light components such as hydrogen can be recovered from gas mixtures using pressure swing adsorption (PSA) with very high purity. In pressure swing adsorption, separation is achieved based on the different adsorption forces of the components to be separated using a cyclic pressure change. Substances that adsorb well to an adsorbent are retained thereon in a step or phase wherein the gas mixture to be separated is passed over the adsorbent at a high pressure (“adsorption phase”). In a subsequent step or phase, these substances are removed from the adsorbent essentially by a pressure relief (“desorption phase”).

Accordingly, there is a high-pressure product obtained in the adsorption phase, typically comprising components with very low boiling points, and a low-pressure product (also called pressure swing adsorption tailgas) obtained in the desorption phase, typically comprising components with higher boiling points.

For further details, reference is made to expert literature, such as the article “Hydrogen, 3. Purification” by Peter Häussinger, Reiner Lohmüller and Allan M. Watson in Ullmann's Encyclopedia of Industrial Chemistry, first published on 15 Oct. 2011, https://doi.org/10.1002/14356007.o13_004.

Using a pressure swing adsorption step without further process steps, it is possible, for example, to extract from a feed gas mixture provided at 30 bar (abs.) high purity hydrogen with e.g. 99.999 mol % hydrogen content at a similar pressure level (high-pressure product). The remaining components of the gas mixture (including non-recovered hydrogen) may be obtained at a lower pressure, for example at a pressure of 5 bar (abs.) (low-pressure product).

Table 1 lists adsorption forces, boiling points and molecular masses for selected substances that may at least in part be included in component mixtures according to embodiments of the present invention.

TABLE 1

| | | Boiling point [K] | Molecular mass |
|---|---|---|---|
| Component | Adsorption force | at 1 bar (abs.) | (rounded) |
| He | | 4 | 4 |
| H₂ | Very weak | 20 | 2 |
| N₂ | | 77 | 28 |
| CO | Medium | 82 | 28 |
| O₂ | | 90 | 32 |
| CH₄ | Medium | 111 | 16 |
| C₂H₆ | Strong | 184 | 30 |
| CO₂ | Strong | 195 (subl.) | 44 |
| C₃H₈ | Strong | 231 | 44 |
| H₂O | Very strong | 373 | 18 |

Pressure swing adsorption may have the disadvantage that the yield of the component to be recovered at the high pressure, for example hydrogen, can be quite low, for example only 70 to 90%. At the same time, substantial amounts of the component to be recovered at high pressure are also still present in the pressure swing adsorption tail gas, i.e. the concentration of the light boiling component in the pressure swing adsorption tail gas can still be high.

Various processes have been developed to improve the purity of pressure swing adsorption tail gas. Reference is e.g. made to U.S. Pat. No. 3,838,553 A. Such processes include compression of the low-pressure product and cryogenic separation and/or partial condensation, as well as recycling of the non-condensed components to the pressure swing adsorption step. Such methods work particularly well when the products to be separated have very widely separated boiling points, or generally if the components to be separated from the target compound have comparatively higher boiling points. This applies, for example, to the separation of hydrogen from the components ethane, carbon dioxide and/or propane. However, if the components to be separated from the high-pressure product also have a low boiling point, such as nitrogen, carbon monoxide, oxygen or methane, cryogenic separation has generally proven to be costly and/or difficult.

The present invention has the object to improve separation, using pressure swing adsorption, of a light component, such as hydrogen, from a corresponding component mixture including further light components.

### DISCLOSURE OF THE INVENTION

Against this background, a method and an apparatus for separating a component mixture containing light components comprising the features of the independent claims is provided. Preferred embodiments of the invention are the subject of the dependent claims and of the description that follows.

According to the present invention, a method for separating hydrogen from methane in a component mixture containing light components is provided, the light components including hydrogen, methane and preferably at least one further component selected from nitrogen, carbon monoxide and oxygen, wherein a pressure swing adsorption feed stream is formed at a first pressure level, wherein the pressure swing adsorption feed stream is subjected to a pressure swing adsorption step, wherein a high-pressure product at the first pressure level and a low-pressure product at a second pressure level below the first pressure level are withdrawn from the pressure swing adsorption step, wherein a membrane feed stream is formed at a third pressure level at or above the second pressure level using the low-pressure product or a part thereof, wherein the membrane feed stream is subjected to a membrane separation step, wherein a retentate at the third pressure level and a permeate at a fourth pressure level below the third pressure level are withdrawn from the membrane separation step, wherein the pressure swing adsorption feed stream is formed using the permeate or a part thereof, and wherein the pressure swing adsorption feed stream and/or the membrane feed stream is formed using the component mixture or a part thereof.

If hereinbelow, reference is made to a feed stream “being formed” using one stream, this is not intended to exclude that such a stream is not formed using a further stream as well. In embodiments of the present invention, for example, the pressure swing adsorption feed stream may be formed using the permeate stream or a part thereof, and optionally the component mixture or a part thereof, and the membrane feed stream may be formed using the formed using the low-pressure product or a part thereof and optionally the component mixture or a part thereof. That is, the component mixture may be completely or in part be combined with the permeate stream or a part thereof to form the pressure swing adsorption feed stream, while the membrane feed stream is not formed by combining the component mixture or a part thereof and the low-pressure product or a part thereof. In an alternative, the component mixture may be completely or in part be combined with the low-pressure product or a part thereof to form the membrane feed stream while the pressure swing adsorption feed stream is not formed by combining the component mixture or a part thereof and the low-pressure product or a part thereof. In a further alternative, a part of the component mixture may be combined with the permeate or a part thereof to form the pressure swing adsorption feed stream and a further part of the component mixture may be combined with the low-pressure product or a part thereof to form the membrane feed stream.

Herein, the term “pressure level” is used in order to express that no exact pressures but pressure ranges can be used in order to realise the present invention and advantageous embodiments thereof. Different pressure levels may lie in distinctive ranges or in ranges overlapping each other. They also cover expected and unexpected, particularly unintentional, pressure changes, e.g. inevitable pressure or temperature losses. Values expressed for pressure levels in bar units are generally absolute pressure values (bar abs.).

In methods according to embodiments of the present invention, a pressure swing adsorption step and a membrane separation step may each can be realized using corresponding units of a plurality of sub-units such as adsorber vessels or membrane cartridges and associated apparatus as known to the skilled person. The pressure swing adsorption step may also be performed at least in part as a vacuum pressure swing adsorption step wherein the low-pressure product is obtained at a sub-atmospheric pressure level.

The proposed method overcomes the problems of low product purity of a pressure swing adsorption tail gas or low yield of the pressure swing adsorption high pressure product as discussed above. In embodiments of the present invention, an interconnection of a pressure swing adsorption step with a membrane separation step increases the yield of the pressure swing adsorption high pressure product and at the same time increases the purity of the product with the higher boiling components. For example, by interconnecting the pressure swing adsorption step with the membrane separation step, a higher overall yield of hydrogen is achieved, even though the pressure swing adsorption only provides a yield of 85%, for example.

Depending on the objective, the composition of the compositions to be treated according to the present invention can be different, as explained below. The present invention is advantageous over the prior art, such as e.g. the process described in U.S. Pat. No. 3,838,553 A, for example, as it is substantially less complex for the separation of light and very light boiling components and is less apparatus and in some examples less energy intensive.

In an embodiment of the present invention, the component mixture may contain less than 90 mol % of hydrogen and methane and may further contain at least one further component selected from nitrogen, carbon monoxide and oxygen. Particularly, such a component mixture may be a so-called tail gas from a cryogenic separation train of a steamcracker unit, a synthesis gas or a different gas mixture having a similar composition.

In an embodiment of the present invention, however, a common content of hydrogen and methane in the component mixture is more than 95 mol %, more than 98 mol % or more than 99 mol %. This is what is meant below if reference is made to a mixture comprising “essentially” hydrogen and methane. Particularly, such a component mixture may particularly a tail gas from a separation train of a steamcracker as mentioned above or a different gas mixture having a similar composition. The remainder not included in common content of hydrogen and methane may e.g. include carbon monoxide, carbon dioxide, and hydrocarbons heavier than methane.

In such an embodiment, a content of hydrogen in the component mixture may be 5 to 95 mol % and the content of methane in the component mixture may be the remainder of the common content of hydrogen and methane in the component mixture. The hydrogen content may e.g. be 70 to 90 mol %, particularly at or around 80 mol %, and the methane content may be 15 to 25 mol %, particularly at or around 19 mol %. The high pressure product may comprise hydrogen in a content of 90 to 100 mol %, e.g. at or around 99% or 99.995 mol %.

In an embodiment of the present invention, the third pressure level may be at the second pressure level, particularly if the first pressure level is sufficiently high and/or the pressure swing adsorption step is performed such in a manner suitable to provide the low-pressure product thereof at a sufficiently high pressure for being passed to the membrane separation step without further compression. A corresponding embodiment of the present invention may thus dispense of a compressor for compressing the low-pressure product of the pressure swing adsorption step, but a compressor for compressing the permeate to be recycled to the pressure swing adsorption step may be required.

In such an embodiment of the present invention, the first pressure level may be 20 to bar abs., e.g. at or around 30 bar abs., the second and the third pressure level may be 3 to 10 bar abs., e.g. at or around 5 bar abs., and the fourth pressure level may be 0.5 to 1.5 bar abs., e.g. at or around 1 bar abs.

In an alternative embodiment of the present invention, the third pressure level may, however, also be above the second pressure level, particularly if the first pressure level the pressure swing adsorption step is, or may not be, performed such as to provide the low-pressure product thereof at a sufficiently high pressure for being passed to the membrane separation step without further compression. A corresponding embodiment of the present invention may thus include a compressor for compressing the low-pressure product of the pressure swing adsorption step, but a compressor for compressing the permeate to be recycled to the pressure swing adsorption step may be omitted.

In such an embodiment of the present invention, the first pressure level may be 3 to 10 bar abs., e.g. at or around 5 bar abs., the second pressure level may be 0.5 to 1.5 bar abs., e.g. at or around 1 bar abs., the third pressure level may be 20 to 30 bar abs., e.g. at or around 25 bar abs., and the fourth pressure level may be 3 to 10 bar abs., e.g. at or around 5 bar abs.

In embodiments of the present invention, the retentate or a part thereof may be passed to a further processing step such as a reforming step, and the high-pressure product or a part thereof may be passed to a combustion step or a different use, depending on its purity, in particular.

In embodiments of the present invention, at least one of the component mixture or a part thereof, the adsorption feed stream or a part thereof, the high-pressure product or a part thereof, the low-pressure product or a part thereof, the membrane feed stream or a part thereof, the retentate or a part thereof, and the permeate or a part thereof may be subjected one or more compression steps. That is, all feed and/or product streams may be subjected to compression, if needed, and depending on required conditions inside and outside the process or apparatus.

In embodiments of the present invention, any compression step, i.e. the or at least one of the compression steps just mentioned, may be performed using at least one of a piston compressor, a screw compressor and a turbo compressor and/or using mechanical energy produced in an expansion step to which any of the feed and/or product streams may be subjected, or at least two of the compression steps may be performed using a common machine including e.g. different turbo wheels.

In embodiments of the present invention, any further method steps may be included, i.e. at least one step selected from a heat exchange step, a cooling step, a cryogenic separation or distillation step, a temperature swing adsorption or drying step, a reforming step, a shifting step, a hydrogenation step, an absorptive or scrubbing step, a further membrane separation step and a further pressure swing adsorption step.

An apparatus for separating a component mixture containing light components is also part of the present invention, the light components including hydrogen, methane and preferably at least one further component selected from methane, nitrogen, carbon monoxide and oxygen, wherein the apparatus includes means configured to perform a pressure swing adsorption step and a membrane separation step, to form a pressure swing adsorption feed stream at a first pressure level, to subject the pressure swing adsorption feed stream to the pressure swing adsorption step, to withdraw a high-pressure product at the first pressure level and a low-pressure product at a second pressure level below the first pressure level from the pressure swing adsorption step, to form a membrane feed stream at a third pressure level at or above the second pressure level using the low-pressure product or a part thereof, to subject the membrane feed stream to the membrane separation step, to withdraw a retentate at the third pressure level and a permeate at a fourth pressure level below the third pressure level from the membrane separation step, to form the pressure swing adsorption feed stream using the permeate or a part thereof, and to form the pressure swing adsorption feed stream and/or the membrane feed stream using the component mixture or a part thereof.

As to specific further features and embodiments of such an apparatus, reference is made to the explanations above relating to the method according to the invention and its advantageous embodiments. This equally applies for a corresponding apparatus which is adapted to perform a corresponding method or one of its embodiments. Such an apparatus may particularly include a control unit programmed or adapted to control the apparatus accordingly.

### SHORT DESCRIPTION OF THE FIGURES

FIGS. 1 to 3 illustrate embodiments of methods provided according to the present invention in the form of simplified process flow or block diagrams.

### EMBODIMENTS OF THE PRESENT INVENTION

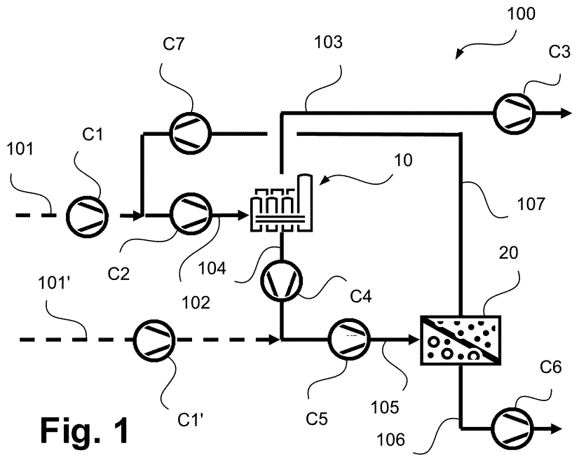

In FIGS. 1 to 3, embodiments of methods provided according to the present invention are illustrated and designated 100, 200 and 300, respectively. In these methods, a pressure swing adsorption step 10 and a membrane separation step 20 are used, which each can be realized using corresponding units of a plurality of sub-units such as adsorber vessels or membrane cartridges and associated apparatus. If reference is made to method steps, the corresponding explanations likewise apply to such units or sub-units used in a corresponding method and vice versa.

In all cases shown, the methods 100, 200 and 300, a component mixture 101 containing light components as mentioned above and further explained below is provided. A pressure swing adsorption feed stream 102 is formed at a first pressure level as indicated below. The pressure swing adsorption feed stream 102 is subjected to the pressure swing adsorption step 10, and a high-pressure product 103 at the first pressure level and a low-pressure product 104 at a second pressure level below the first pressure level are withdrawn from the pressure swing adsorption step 10.

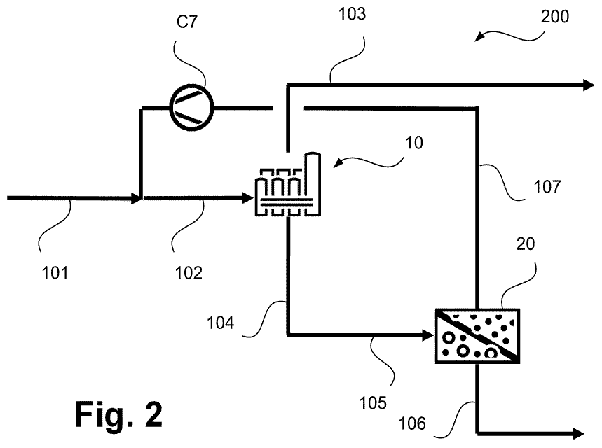

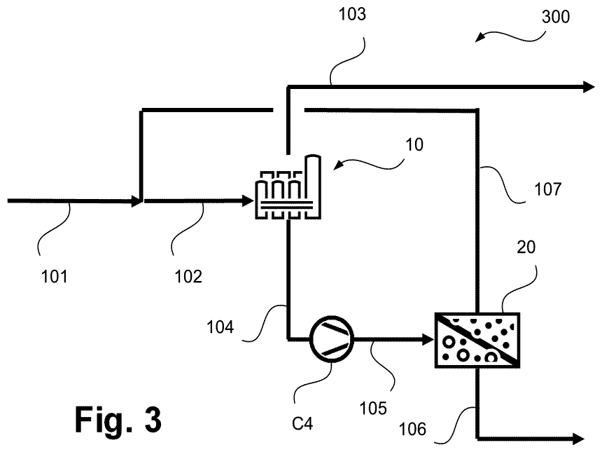

A membrane feed stream 105 is formed at a third pressure level at or above the second pressure level using the low-pressure product 104 or a part thereof, and the membrane feed stream is subjected to a membrane separation step 20. A retentate 106 at the third pressure level and a permeate 107 at a fourth pressure level below the third pressure level are withdrawn from the membrane separation step 20. The pressure swing adsorption feed stream 102 is formed using the permeate 107 or a part thereof. As illustrated in FIG. 1, the component mixture 101 may used, at least in part(s), in forming the pressure swing adsorption feed stream 102 and/or the membrane feed stream 105 (as indicated with 101′), as explained in detail above. A single, common, or separate compression C1 (and C1′) may be performed. These alternatives may, albeit not explicitly illustrated, be part of the embodiments illustrated in FIGS. 2 and 3 as well.

As illustrated in FIG. 1, in the method 100, the component mixture 101 (and/or 101′) may e.g. be a tail gas from a steamcracking unit containing hydrogen and methane or a similar gas mixture. As illustrated for the alternative in which a part or all of the component mixture 101 is used in forming the pressure swing adsorption feed 102, this, or this part, of the component mixture 101 may be compressed using the compressor C1 is then combined with the permeate 107 or a part thereof, which may itself have been compressed using a compressor C7, while a further compression may be performed in a compressor C2 to form the pressure swing adsorption feed stream 102.

The low-pressure product 104 or a part thereof may be compressed using a compressor C4. After the low-pressure product 104 or a part thereof compressed using the compressor C4 is combined (in the alternative illustrated above) with the, or a part of, the component mixture C1′, which may itself have been compressed using a compressor C1′, a further compression can be performed in a compressor C5 to form the membrane feed stream 105.

The high-pressure product 103, containing light components such as hydrogen, nitrogen, carbon monoxide and oxygen, may be provided as a product of the method 100 and may be further compressed using a compressor C3. The retentate 106, containing methane, and a small part of some of the light components, such as nitrogen, carbon monoxide, oxygen and hydrocarbons with more than one carbon atom, may be withdrawn from method 100 and may be further compressed using a compressor C6.

As illustrated in FIG. 2, in the method 200, the component mixture 101, which may e.g. be a tail gas from a steamcracking unit containing essentially hydrogen and methane, or a similar gas mixture, may be used completely for forming the pressure swing adsorption feed stream 102 (although the options illustrated in FIG. 1 are generally possible here as well). In the method 200, compressors C₁ to C₆ shown in FIG. 1, which are not illustrated in FIG. 2, may be present or may be selectively omitted. In this example, membrane feed stream 105 is particularly formed at the third pressure level which is here at the second pressure level. In this example, the first pressure level may be at or around 30 bar (abs.), the second and third pressure levels may be at or around 5 bar (abs.), and the fourth pressure level may be at or around 1 bar (abs.).

The high-pressure product 103, containing, in the method 200, essentially hydrogen, may be provided as a product of the method 200 and the retentate 106, containing essentially methane, may be withdrawn from method 200.

In method 200 illustrated in FIG. 2, the component mixture 101 may particularly be provided containing predominantly hydrogen (5 to 95 mol %, e.g. 80 mol %), methane (5 to 95 mol %, e.g. 19 mol %), and small amounts of other hydrocarbons (0 to 10 mol %, e.g. 1 mol %). This component mixture 101 may be provided at or around 30 bar (abs.), as mentioned. Separation by pressure swing adsorption occurs and hydrogen is recovered, in the high-pressure product 103, at or around 30 bar (abs.), with a purity of 90 to 100 mol % (e.g. 99.995 mol %) and a yield of 60 to 95% (e.g. 85%). A pressure swing adsorption tailgas stream, i.e. the low pressure product 104, is present at or around 5 bar (abs.), as mentioned, and contains the remaining hydrogen, as well as methane and other hydrocarbons. The membrane separation step 20 is performed and the retentate 106 is produced at or around 5 bar (abs.), as mentioned, which contains only a small amount of hydrogen (e.g. 2 mol %). The remaining gas, i.e. the permeate 107, contains predominantly hydrogen as well as certain amounts of methane and is present at or around 1 bar (abs.), as mentioned. Finally, a compression using compressor C7 to at or around 30 bar (abs.) is performed, as also mentioned, and the permeate 107 is fed to the pressure swing adsorption together with the component mixture 101.

By interconnecting the pressure swing adsorption step 10 with the membrane separation step 20, a higher overall yield of hydrogen is achieved, although the pressure swing adsorption only provides a yield of, for example, 85%.

Also in the method 300 illustrated in FIG. 3, the component mixture 101, which may e.g. be a tail gas from a steamcracking unit containing essentially hydrogen and methane, or a similar gas mixture, may be used completely for forming the pressure swing adsorption feed stream 102 (although the options illustrated in FIG. 1 are generally possible here as well). In the method 300, compressors C₁ to C₃ and C₅ to C₇ shown in FIG. 1, which are not illustrated in FIG. 3, may be present or may be selectively omitted. In this example, membrane feed stream 105 is particularly formed at the third pressure level which is here above the second pressure level using compressor C5. In this example, the first pressure level may be at or around 5 bar (abs.), the second pressure level may be at or around 1 bar (abs.), the third pressure level may be at or around 25 bar (abs.), and the fourth pressure level may be at or around 5 bar (abs.).

As explained for method 200, the high-pressure product 103, containing, in the method 300, essentially hydrogen, may be provided as a product of the method 300 and the retentate 106, containing essentially methane, may be withdrawn from method 300.

In method 200 illustrated in FIG. 2, the component mixture 101 may particularly be provided containing predominantly hydrogen (5 to 95 mol %, e.g. 80 mol %), methane (5 to 95 mol %, e.g. 19 mol %) and small amounts of other hydrocarbons (0 to 10 mol %, e.g. 1 mol %). This component mixture 101 may be provided at or around 5 bar (abs.), as mentioned. Separation is, as above, initially performed by pressure swing adsorption and hydrogen is obtained, in the high-pressure product 103 at about 5 bar (abs.), as mentioned, with a purity of 90 to 100 mol % (e.g. 99 mol %) and a yield of 60 to 95% (e.g. 85%). This hydrogen is suitable for low carbon dioxide combustion in a steamcracker, for example. The pressure swing adsorption tailgas stream, i.e. the low-pressure product 104, is present at or around 1 bar (abs.), as mentioned, and contains the remaining hydrogen, as well as methane and other hydrocarbons. Finally, a compression using compressor C4 at or around 25 bar (abs.) is performed, and a separation by means of membrane separation step 20 is performed. The retentate 106 is generated at or around 25 bar (abs.), as mentioned, which contains only a small amount of hydrogen (e.g. 2 mol %). This methane-rich stream is suitable for use in a synthesis gas process. The synthesis gas process can include an autothermal reforming as well as a CO shift and a CO2 separation, with the aim to produce hydrogen. The residual gas from the membrane separation step 20, i.e. permeate 107, contains predominantly hydrogen as well as certain amounts of methane and is present at about 5 bar (abs.), as mentioned. The permeate 107 is fed to the pressure swing adsorption together with the component mixture 101.

For the avoidance of doubt, the present invention is not limited to the embodiments shown in FIGS. 1 to 3 but limited by the claims. A plurality of variations of the embodiments shown in the Figures is envisaged by the present invention. For the separation of methane and higher hydrocarbons (particularly hydrocarbons with two carbon atoms, for example), there may be different feed concentrations and therefore requirements as to feed and product pressure(s). These requirements essentially determine at which positions the compression steps are performed and whether a compression is made at different positions.

1. A method for separating hydrogen from methane in a component mixture containing light components, the light components including hydrogen and methane, wherein a pressure swing adsorption feed stream is formed at a first pressure level, wherein the pressure swing adsorption feed stream is subjected to a pressure swing adsorption step, wherein a high-pressure product at the first pressure level and a low-pressure product at a second pressure level below the first pressure level are withdrawn from the pressure swing adsorption step, wherein a membrane feed stream is formed at a third pressure level at or above the second pressure level using the low-pressure product or a part thereof, wherein the membrane feed stream is subjected to a membrane separation step at the third pressure level and a permeate; at a fourth pressure level below the third pressure level are withdrawn from the membrane separation step, wherein the pressure swing adsorption feed stream is formed using the permeate; or a part thereof, and wherein the pressure swing adsorption feed stream and/or the membrane feed stream is formed using the component mixture or a part thereof.

2. The method according to claim 1, according to claim 1, wherein the component mixture contains less than 90 mol % of hydrogen and methane and further contains at least one further component selected from nitrogen, carbon monoxide and oxygen.

3. The method according to claim 1, wherein a common content of hydrogen and methane in the component mixture is more than 95 mol %, more than 98 mol % or more than 99 mol %.

4. The method according to claim 2, wherein a content of hydrogen in the component mixture is 5 to 95 mol % and wherein the content of methane in the component mixture is the remainder of the common content of hydrogen and methane in the component mixture.

5. The method according to claim 3, wherein the third pressure level is at the second pressure level.

6. The method according to claim 5, wherein the first pressure level is 20 to 40 bar abs., the second and the third pressure level is 3 to 10 bar abs. and the fourth pressure level is 0.5 to 1.5 bar abs.

7. The method according to claim 3, wherein the third pressure level is above the second pressure level.

8. The method according to claim 7, wherein the first pressure level is 3 to 10 bar abs., the second pressure level is 0.5 to 1.5 bar abs., the third pressure level is 20 to bar abs. and the fourth pressure level is 3 to 10 bar abs.

9. The method according to claim 3, wherein the retentate or a part thereof is passed to a reforming step.

10. The method according to claim 3, wherein the high-pressure product or a part thereof is passed to a combustion step.

11. The method according to claim 1, wherein at least one of the component mixture or a part thereof, the adsorption feed stream or a part thereof, the high-pressure product or a part thereof, the low-pressure product or a part thereof, the membrane feed stream or a part thereof, the retentate or a part thereof, and the permeate or a part thereof are subjected one or more compression steps.

12. The method according to claim 11, wherein the compression step or at least one of the compression steps is performed using at least one of a piston compressor, a screw compressor and a turbo compressor and/or using mechanical energy produced in an expansion step, or wherein at least two of the compression steps are performed using a common machine.

13. The method according to anyone claim 1, further including at least one step selected from a heat exchange step, a cooling step, a cryogenic separation or distillation step, a temperature swing adsorption or drying step, a reforming step, a shifting step, a hydrogenation step, an absorptive or scrubbing step, a further membrane separation step and a further pressure swing adsorption step.

14. An apparatus for separating hydrogen from methane in a component mixture containing light components, the light components including hydrogen and methane, wherein the apparatus includes means configured to perform a pressure swing adsorption step and a membrane separation step, to form a pressure swing adsorption feed stream at a first pressure level, to subject the pressure swing adsorption feed stream to the pressure swing adsorption step, to withdraw a high-pressure product at the first pressure level and a low-pressure product at a second pressure level below the first pressure level from the pressure swing adsorption step, to form a membrane feed stream at a third pressure level at or above the second pressure level using the low-pressure product or a part thereof, to subject the membrane feed stream to the membrane separation step, to withdraw a retentate at the third pressure level and a permeate at a fourth pressure level below the third pressure level from the membrane separation step, to form the pressure swing adsorption feed stream using the permeate or a part thereof, and to form the pressure swing adsorption feed stream and/or the membrane feed stream using the component mixture or a part thereof.

15. (canceled)

16. The apparatus according to claim 14, further comprising means configured to perform a method for separating hydrogen from methane in a component mixture containing light components, the light components including hydrogen and methane, wherein a pressure swing adsorption feed stream is formed at a first pressure level, wherein the pressure swing adsorption feed stream is subjected to a pressure swing adsorption step, wherein a high-pressure product at the first pressure level and a low-pressure product at a second pressure level below the first pressure level are withdrawn from the pressure swing adsorption step, wherein a membrane feed stream is formed at a third pressure level at or above the second pressure level using the low-pressure product or a part thereof, wherein the membrane feed stream is subjected to a membrane separation step, wherein a retentate at the third pressure level and a permeate at a fourth pressure level below the third pressure level are withdrawn from the membrane separation step, wherein the pressure swing adsorption feed stream is formed using the permeate or a part thereof, and wherein the pressure swing adsorption feed stream and/or the membrane feed stream is formed using the component mixture or a part thereof.
